(19) United States
(12) Patent Application Publication
(10) Pub. No.: US 2009/0192642 A1
(43) Pub. Date: Jul. 30, 2009

(54) Method and apparatus for operating a test plant

(75) Inventors: Michael Conrad, Ottweiler (DE); Alexander Kurz, Hofheim-Wallau (DE)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: AVL LIST GMBH

(21) Appl. No.: 12/308,759

(22) PCT Filed: Jun. 26, 2007
(86) PCT No.: PCT/AT2007/000314

§ 371 Date: Feb. 5, 2009

(30) Foreign Application Priority Data
Jun. 27, 2006 (AT) A 1084/2006

(51) Int. Cl. G05B 13/02; G06F 19/00

(52) U.S. Cl. 700/100; 700/105

(57) ABSTRACT

The operation of a test plant comprising a series of test rooms with a respective number of test beds requires management of a multiplicity of data, resources, people, processes, etc. Optimum operation of a test plant with as little unproductivity as possible is possible only when all of this information is networked together and optimum structures for the separation and management of a test plant are created. To this end, the invention now proposes splitting a test order into an order specimen and a process specimen, the two specimens being used to store different information. By linking an order specimen to a process specimen and the associated data and processes, it is a simple matter to generate a test process plan, and the handling of the test job can be controlled and monitored on the basis of the test process plan.

A method and apparatus for operating a test plant having at least one test room comprising a number of test beds for carrying out various test jobs on various test objects, wherein the test plant is given a test order for carrying out a test job.

When a test job is carried out on a test bed, a wide variety of requirements need to be met, a wide variety of data need to be taken into account and tasks need to be accomplished. By way of example, certain resources, data and processes are required, such as test equipment, sensors, measuring equipment, test beds, data relating to test objects, such as specifications, configurations, technical data, various parameters, etc., project management, test processes, etc., which turns a test job into a complex operation. The matter is also complicated by the fact that a test job usually involves several people with different tasks, e.g. a development engineer, who gives a test order, a test engineer, who implements the test order, engineers who manage, calibrate and maintain the test object and the test equipment, and operators, who carry out the test. It also requires individual people to access data for a wide variety of areas which are usually stored and managed differently. For a single test bed, these resources, data and processes are still manageable. The matter becomes much more difficult in the case of test rooms in which a multiplicity of test beds are operated in parallel and simultaneously. To be able to manage such test rooms, individual tools have been created, but these cover only single aspects of a test operation. This less than optimum networking of the data, processes and resources results in increased downtimes, in unproductive testing time, manual data input, capacity bottlenecks in test mode, which is naturally also reflected in higher costs for the test mode.

The current trend is now in a direction of test plants, which may contain a series of test rooms with a multiplicity of test beds. These test rooms may even be in separate locations. The management and operation of such test plants make very high demands on appropriate test room management and further exacerbate the aforementioned problems tremendously.

The object of the concrete invention is thus to reduce the aforementioned drawbacks in a method and a corresponding apparatus for operating a test plant and to allow simple and flexible management of a test plant.

The invention achieves this object for the method and the apparatus in that the operating process required for this test order is determined in the test plant and is created and stored in an order planning unit as an order specimen in association with this test order, wherein, in addition, the resources and technical test processes required for this test job are determined and are created and stored in a process planning unit as a process specimen in association with the respective test job, and wherein a test job control unit links the order specimen and the process specimen and the associated data and processes to one another and generates a test process plan therefrom and controls and monitors the handling of the test job on the basis of the test process plan. The creation of an order specimen and a process specimen provides the greatest possible flexibility, since underlying processes such as a business process of the test plant operator and a technical process of a test are separated. This avoids double definitions of data and processes. In addition, this approach of creating order and process specimens affords the opportunity for at least partial automation of the creation and performance of a test order, since the specimens enable the system to create, carry out and monitor a test process at least to some extent independently.

Further advantages and aspects of the invention can be found in the description below and the claims.

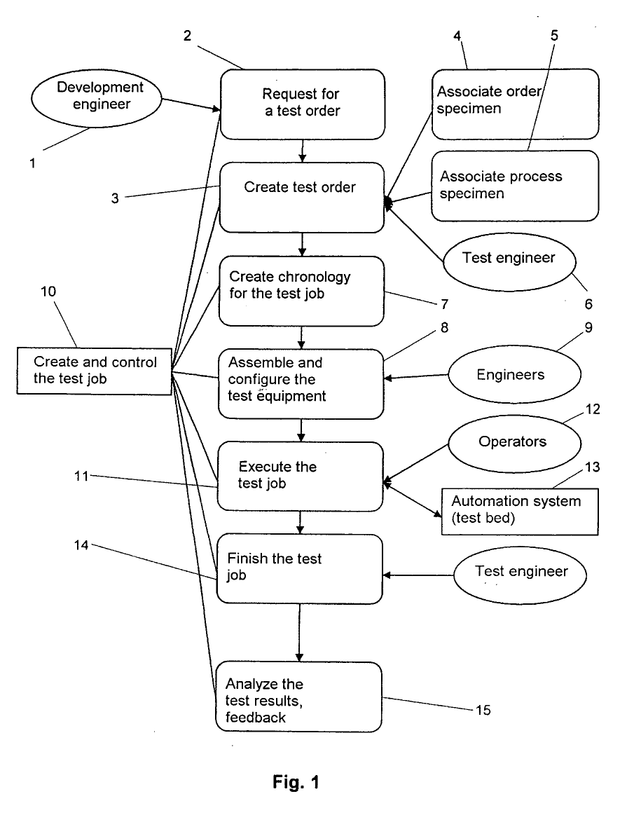

The concrete invention is described below with reference to the schematic, nonrestrictive FIGS. 1 to 3, which each relate to exemplary embodiments of the invention and in which

FIG. 1 shows a flow chart for the handling of a test job,

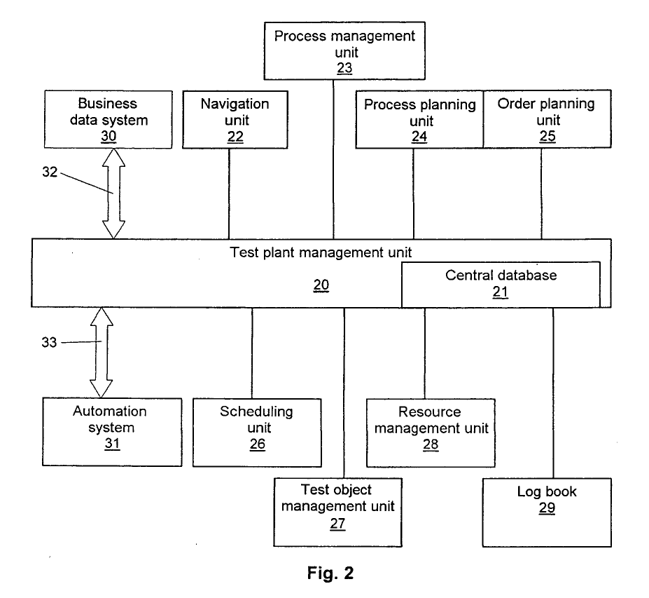

FIG. 2 shows an arrangement for handling a test job, and

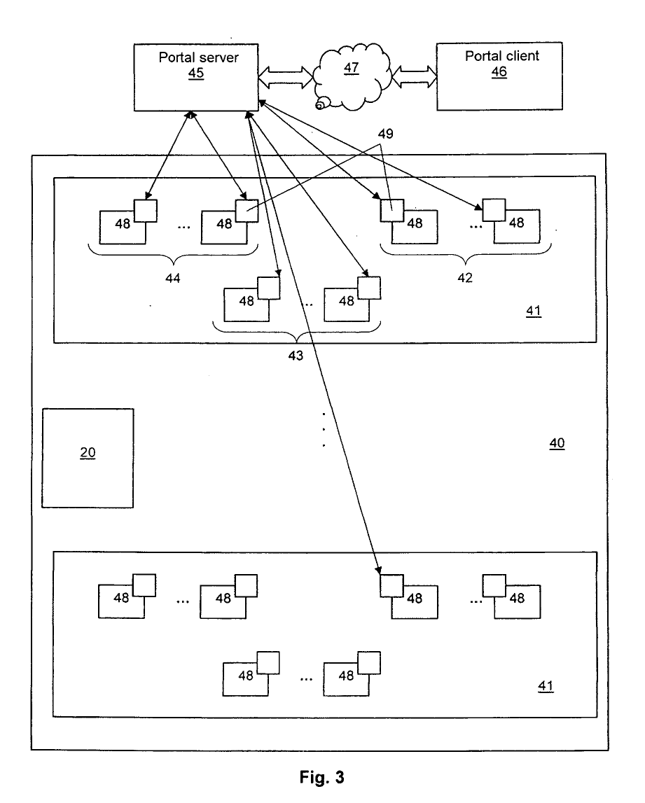

FIG. 3 shows an external interface of the test plant.

As FIG. 1 shows, a development engineer 1 creates a request for a test order 2. This test order request 2 essentially contains the test job, that is to say the information regarding which test object, e.g. a motor, a transmission, a drive train or a particular component of a machine, needs to have which aspects tested. This may be, for example, an endurance test on a transmission, motor or vehicle, optimization of particular components, simulation of a particular use or a development test on a particular component. From this abstract requirement 2, the invention now involves the creation of a test process plan which can be used to implement the test order requirement 2 in concrete terms. To this end, in a first step, a test engineer 6 associates an appropriate order specimen 4 and an appropriate process specimen 5 with the abstract test order requirement 2.

In this context, the order specimen 4 contains a template for how particular orders need to be carried out within the test plant, that is to say the implementation of a business process of the test plant operator, for example. By way of example, this may record how the test plant needs to be operated, what administrative steps are required and in what order, how test orders are received and checked, what documentation is necessary, what quality criteria need to be met, where the test object (e.g. motor) is set up (e.g. is there a prelaunch space?), etc. However, an order specimen 4 of this kind does not yet contain a specific embodiment but rather only a basic operating process. Within the test plant or a test room, there may be respective different order specimens for various areas, such as component test beds, transmission test beds and motor test beds. The process specimen 5, on the other hand, records what resources, such as test beds, measuring equipment, sensors, operators, etc., are required for carrying out the test job, when and for how long what resource is required, system parameters, process programs for the test beds, what measurement points are required, etc., that is to say the technical process within a particular business process (order specimen). However, a process specimen 5 of this kind does not yet contain a specific embodiment, but rather only the basic technical process and resources which are required therefor.

In a test plant, there will naturally be a multiplicity of process specimens 5 and at least one order specimen 4 in order to be able to implement all the test orders. These can now be created in advance, e.g. if the preparatory work involves all the processes of the test plant operator being analyzed and being implemented in appropriate order and process specimens 4, 5 in advance. Alternatively, these can be created in the course of a new test order requirement 2, e.g. by the test engineer 6 when there is not yet an appropriate order or process specimen 4, 5.

The order specimen 4 and the process specimen 5 can now be used to automatically create a specific test order for the test plant with the test process plan, 3. To do this, a central test plant management unit 20 is provided which creates the test process plan and also executes it and monitors the execution, 10. To this end, the order specimen 4 and the process specimen 5, that is to say the resources, data, processes and information stored therein, are linked to one another. The required resources are specifically associated in this case, e.g. are associated with measuring equipment, test beds, etc. available in the test room or in the test plant and required on the basis of the process specimen 5, and reserved. The scheduling of the test process is carried out with the available information, and the required resources are reserved on the basis of the time requirements, 7. This is done either manually or by a scheduling unit 26 (see below). Test beds or measuring configurations are assembled and parameterized in line with the requirements, 8. Personnel required for this, such as engineers 9, are reserved and scheduled.

The test process plan automatically created in this manner is then used to create the test configuration and to carry out the test job, 11, for which purpose appropriate operators 12 may be scheduled. Carrying out the test job may also require an appropriate process program to be transferred to the test bed used or to its automation system, 13, so that the test job proceeds at least to some extent automatically on the test bed.

When the test job is finished, 14, the result can be checked for plausibility by a test engineer, for example, and ultimately released. Alternatively, the test result, and also the history of the test, can be stored and archived in a database. It is equally possible to analyze the test process at the end of the test job, or else now and then. This can be used to optimize the test process, for example. Such feedback information 15 can be used, by way of example, to learn and, for example, to change or customize the underlying process specimens or order specimens in order to obtain better results upon the next pass or to prevent certain errors. In this case, the configuration of a performed test process should, however, be retained and remain retrievable in view of later reconstructability and repeatability.

To be able to accomplish these tasks, a test plant management unit 20 may be provided which is a central unit and coordinates and manages all tasks and operations. In this case, the test plant management unit 20 is advantageously a server which can be accessed by all the other units involved. The units involved may be separate computer systems which are connected in a network, but may also be software modules which run on the server, that is to say in the test plant management unit 20. In addition, the test plant management unit 20 also advantageously comprises a central database 21 which stores all data, processes and information relating to the test plant centrally, which means that they can be retrieved by all the units involved. This ensures optimum networking of all data, processes and information within the test plant and prevents unwanted multiplication of data.

A process 24 and order planning unit 25 is provided which is connected to the test plant management unit 20 and runs in it in integrated form. These units store the process specimens and order specimens in retrievable form. The associated data, such as resources, technical processes, etc., are advantageously stored in a central database 21. The process and order planning units 24, 25 also advantageously provide a user interface which can be used to create, change and manage order specimens and process specimens. The order and process planning units 24, 25 may also be integrated in a single unit.

A resource management unit 28 may also be provided which is connected to the test plant management unit 20 and runs in it in integrated form. The resource management unit 28 is a central inventory and management unit for all the resources in the test plant, that is to say, by way of example, for measuring equipment, test beds, sensors, etc. All data and information relating to the resources, e.g. parameters, calibration data, documentations, assembly instructions, maintenance data, etc., are again advantageously stored in the central database 21 in this instance. This means that the resources can be managed using a single unit throughout their life. This also allows simple tracing of particular measurements to associated resources and calibration data. Similarly, it is also possible to manage time-related data, such as the time taken for assembly, start-up, configuration changes etc., which can be utilized by the scheduling unit 26. In this case, the resources can also be stored and managed in the form of logical configurations. A configuration of this kind describes a unit comprising a plurality of individual resources which belong together logically and functionally, that is to say a complete logical test bed setup with all of its equipment and capabilities, for example. On the basis of the requirements, e.g. a list of measurement points, it is then possible to determine an appropriate measurement configuration and select it for the test order. The resource management unit 28 also advantageously provides a user interface which can be used to create, change and manage resources and configurations.

A separate scheduling unit 26, which is connected to the test plant management unit 20 and runs in it in integrated form, could be provided in order to plan the test process timing. In this context, the scheduling unit 26 accesses all data in the central database 21 and generates an appropriate optimized time schedule for the test process from the data which are stored in said central database for the individual resources required for a particular test order or test process and which are relevant to the scheduling, such as maintenance periods for measuring equipment, use of test beds, measuring equipment, use of personnel, time taken for measurements, etc. This means that it is also possible for time clashes to be taken into account and resolved as appropriate before the start of the test process.

In addition, a test object management unit 27 may be provided which is connected to the test plant management unit 20 and runs in it in integrated form. The test object management unit 27 can be used to manage all test-related data for the individual test objects, such as specifications, parameterizations, current position in the test plant, etc., using one unit. Alternatively, it can be used to record the history of test objects in appropriately reconstructible form over their life. Similarly, it also makes sense to manage time-related data, such as the time taken for assembly, start-up, etc., which data can in turn be utilized by the scheduling unit 26. The test object management unit 27 also advantageously provides a user interface which can be used to create, change and manage test objects.

An electronic log book 29 can be used in order to record all test-related data. By way of example, these may be: personal notices relating to a test process of the personnel, recording of working hours, documentation of the daily work, etc. These data can be automated, possibly associated with a test order, produced and, advantageously, stored in the central database 21. This allows simpler reconstructability of particular processes in the test plant.

A process management unit 23 can be used in order to monitor a test process, for example, that is to say to perform an actual/setpoint comparison, for example, but may also be used to detect weaknesses or errors in a test process by analyzing the test process, e.g. using the log book 29. This may result in the underlying process or order specimen being changed or customized, for example.

To obtain simple and comprehensible access to particular parts of the test plant, e.g. of a single test bed, and the associated data, such as configurations, status, etc., a navigation unit 22 may be provided. This can be used to browse through physical arrangements, such as test beds, test equipment and configurations, test objects, etc., but also through logical objects, such as test orders, test results, etc. The navigation unit 22 may also be in the form of a central interface to the test plant management unit 20, the data stored therein in the central data unit 21 and the units involved.

It is equally possible for the test plant management unit 20 to manage standards and, advantageously, store them in the central database 21, a standard being a particular information unit, such as documents, forms, test parameters, FAQs, various manuals, etc., within the test plant. Such standards may then be part of an order or process specimen or else of a particular resource, of a test object or of a configuration. Standards are advantageously managed with version and history information. This means that it is thus also possible to include general information, for example to assist the personnel.

From the test plant management unit 20, it is also possible to produce interfaces 32, 33 to other external systems. By way of example, an interface 32, for example a network, could be used to connect a business data system, such as SAP. Other interfaces 33 could also be used to connect test bed automation systems 31, such as PUMA OPEN from the applicant. This allows data interchange between the test plant management unit 20 and these external systems and allows the test plant management unit 20 and certain units involved therein to use or update data about standardized interface protocols from these external systems.

Certain units could also be made accessible in a client/server structure. By way of example, a test plant network, with the test plant management unit 20 as a server, could have a series of clients installed in it which can be used to create test orders and to initiate test processes. Similarly, these clients could also comprise the navigation unit 22. Within the test plant network, it would naturally also be possible for appropriate authorizations to be allocated so that not every user can perform all the functions.

Another option is to provide access to the test plant via an external interface, such as the internet 47, as indicated in FIG. 3. To this end, by way of example, a portal server 45 may be provided which is accessible via the internet 47 using a portal client 46, which may be a simple WEB browser, for example. In this case, the portal server 45 is connected to every test bed 48 in every test room 41 in the test plant 40, e.g. via the test plant network. Every test bed 48 may to this end have a data collector 49 which is used to collect particular data from the test bed 48 and to transfer it to the portal server 45. These data can then be retrieved via the portal client 46. This allows remote monitoring and diagnosis of all parts of the test plant 40. Alternatively, it is possible to detect and visualize the status or particular measurement results for individual test beds 48 or test bed groups 42, 43, 44. It would likewise be possible to use the portal server 45 to make changes in the test plant, such as changes relating to a particular test order or test process, externally.

1. A method for operating a test plant (40) having at least one test room (41) comprising a number of test beds (48) for carrying out various test jobs on various test objects, wherein the test plant (40) is given a test order for carrying out a test job, wherein the operating process required for this test order is determined in the test plant (40) and is created and stored in an order planning unit (25) as an order specimen in association with this test order, wherein, in addition, a test bed (48) required for this test job in the test plant (40), and also required resources, parameters and technical test processes, are determined and are created and stored in a process planning unit (24) as a process specimen in association with the respective test job, and wherein a test plant management unit (20) links the order specimen and the process specimen and the associated data, parameters and processes to one another and generates a test process plan therefrom, and the test bed (48) determined for the test job is parameterized by the test plant management unit (20) on the basis of the test process plan, and the test plant management unit (20) controls and monitors the handling of the test job on the assigned test bed in the test plant (40) on the basis of the test process plan.

2. The method as claimed in claim 1, wherein the process specimen is used to store when which resource is required for the test job.

3. The method as claimed in claim 1, wherein the process specimen is used to store system parameters and process programs for at least one test bed.

4. The method as claimed in claim 1, wherein the chronology of the test job is created by a scheduling unit (26) under the control of the test plant management unit (20), and the scheduling unit (26) accesses the data stored in the process and/or order specimen.

5. The method as claimed in claim 1, wherein the resources and configurations required in the test plant (40) are managed using a resource management unit (28), wherein a resource or configuration has its history and/or calibration data and/or test-related data stored for it.

6. The method as claimed in claim 1, wherein the test objects to be tested in the test plant (40) are managed using a test object management unit (27), wherein a test object has its history and/or test-related data stored for it.

7. The method as claimed in claim 1, wherein data, information and processes for the test job are stored in a log book (29) during the test process.

8. The method as claimed in claim 1, wherein the test plant management unit (20) is used to store and manage standards.

9. The method as claimed in claim 1, wherein all the data, processes, standards and/or information is/are stored in a central database (21), and the individual units access this database as required.

10. The method as claimed in claim 1, wherein all data, processes and/or information is/are accessed using a navigation unit (22) as required at any time during the handling of a test job.

11. The method as claimed in claim 1, wherein an external access unit (45) is used to access data, status, processes and/or information for all the test beds (48) in all the test rooms (41) in the test plant (40) as required.

12. The method as claimed in claim 1, wherein data, processes and/or information is/are analyzed in a process management unit (23) during or after handling of the test job, and the underlying process specimen and/or order specimen is/are customized for the purpose of optimization.

13. An apparatus for operating a test plant (40) having at least one test room (41) comprising a number of test beds (48) for carrying out various test jobs on various test objects, wherein the test plant (40) is given a test order for carrying out a test job, wherein an order planning unit (25) is provided which creates and stores the required operating process, created for this test order, in the test plant (40) as an order specimen in association with this test order, wherein, in addition, a process planning unit (24) is provided which creates and stores the test bed (48) ascertained for this test job in the test plant (40) and the required resources, parameters and technical test processes ascertained for this test job as a process specimen in association with the respective test job, and wherein a test plant management unit (20) is provided which links the order specimen and the process specimen and the associated data, parameters and processes to one another and generates a test process plan therefrom, and the test plant management unit (20) parameterizes the test bed (48) determined for the test job on the basis of the test process plan and controls and monitors the handling of the test job in the test plant (40) on the basis of the test process plan.

14. The apparatus as claimed in claim 13, wherein the process specimen stores when which resource is required for the test job.

15. The apparatus as claimed in claim 13, wherein the process specimen stores the system parameters and process programs for at least one test bed (48).

16. The apparatus as claimed in claim 13, wherein a scheduling unit (26) is provided which can be used to create the chronology of the test job under the control of the test plant management unit (20), and the scheduling unit (26) accesses the data stored in the process and/or order specimen.

17. The apparatus as claimed in claim 13, wherein a resource management unit (28) is provided which can be used to manage the resources and configurations required in the test plant (40), wherein a resource or configuration has its history and/or calibration data and/or test-related data stored for it.

18. The apparatus as claimed in claim 13, wherein a test object management unit (27) is provided which can be used to manage the test objects to be tested in the test plant (40), wherein a test object has its history and/or test-related data stored for it.

19. The apparatus as claimed in claim 13, wherein a log book (29) is provided which can be used to store data for the test job during the test process.

20. The apparatus as claimed in claim 13, wherein a central database (21) is provided which can be used to store all the data, processes, standards and/or information and the individual units can access this database as required.

21. The apparatus as claimed in claim 13, wherein a navigation unit (22) is provided which can be used to access all data, processes and/or information at any time during the handling of a test job.

22. The apparatus as claimed in claim 13, wherein an external access unit (45) is provided which can be used to retrieve data, status, processes and/or information for all the test beds (48) in all the test rooms (41) in the test plant (40) as required.

23. The apparatus as claimed in claim 13, wherein a process management unit (23) is provided which can be used to analyze data, processes and/or information during or after the handling of the test job and to customize the underlying process specimen and/or order specimen for the purpose of optimization.
